(19) United States
(12) Patent Application Publication
(10) Pub. No.: US 2018/0229258 A1
(43) Pub. Date: Aug. 16, 2018

(54) WATER AND FIRE ORNAMENTAL DEVICE

(71) Applicant: MOU-LI LIN, TAINAN CITY (TW)

(72) Inventor: MOU-LI LIN, TAINAN CITY (TW)

(21) Appl. No.: 15/429,538

(22) Filed: Feb. 10, 2017

(51) Int. Cl. B05B 17/08

(52) U.S. Cl. CPC B05B 17/085

(57) ABSTRACT

A water and fire ornamental device includes a casing; recessed inward with an accommodation space; a fire source, disposed on the casing, a water intake unit, disposed on the casing and having an outlet end communicating with the accommodation space; a pump motor, being in communication with the accommodation space of the casing and a water intake unit; and a power source electrically connected with the pump motor. The fire source is used to generate a flame. The pump motor pumps a liquid from the accommodation space to the water intake unit. The liquid flows back to the accommodation space from the outlet end of the water intake unit. The flame and the liquid flowing from the outlet end are visible from the outside the casing to achieve the visual perception of water and fire homology.

### FIELD OF THE INVENTION

The present invention relates to a water and fire ornamental device, and more particularly to a device for the ornamental display of the interaction of fire and water.

### BACKGROUND OF THE INVENTION

Water and fire homology is a special landscape of nature. Many viewers highly praise this scene. Thus, there are many products on the market to imitate the scene of water and fire homologous, such as U.S. Patent Application Ser. No. 41/657,094, “FLAMELESS CANDLE DEVICE WITH FOUNTAIN”, filed by the inventor. This application uses light to show light and shadow changes through flowing water to simulate the effect of water and fire homology.

However, in actual use, the inventor found that although the device of the aforesaid application has the effect of similar water and fire homologous, the light to simulate a flame lacks realistic visual experience. Accordingly, the inventor of the present invention has devoted himself based on his many years of practical experiences to solve these problems.

### SUMMARY OF THE INVENTION

The primary object of the present invention is to provide a water and fire ornamental device which adopts a real flame to present the effect of water and fire homology.

In order to achieve the aforesaid object, the water and fire ornamental device of the present invention comprises a casing, a fire source, a water intake unit, a pump motor, and a power source. The casing is recessed inward with an accommodation space. The fire source is disposed on the casing. The water intake unit is disposed on the casing. The water intake unit has an outlet end communicating with the accommodation space. The pump motor is in communication with the accommodation space of the casing and the water intake unit. The power source is electrically connected with the pump motor.

The fire source is used to generate a flame. The pump motor pumps a liquid from the accommodation space to the water intake unit. The liquid flows back to the accommodation space from the outlet end of the water intake unit. The flame and the liquid flowing from the outlet end are visible from an outside the casing.

Preferably, the fire source includes a flame pipe and a gas connector connected to the flame pipe.

Preferably, the gas connector has a gas connection end extending outward from a bottom of the casing.

Preferably, the water intake unit is a water tank, and the outlet end is disposed at an overflow end of the water tank.

Alternatively, the water intake unit is a water pipe. The water pipe has the outlet end facing up. A stop board is provided and located corresponding to the outlet end, so that the liquid is stopped by the stop board to flow back to the accommodation space when the liquid is ejected upward from the outlet end.

Preferably, the casing is provided with a first decorative panel. The first decorative panel is located close to the outlet end of the water intake unit. The first decorative panel has a plurality of ribs thereon.

Preferably, the casing is provided with a second decorative panel. The second decorative panel covers the fire source and the water intake unit. The second decorative panel has a first opening for the flame to come out and a second opening corresponding to the outlet end of the water intake unit. The second opening is covered by the first decorative panel.

Preferably, two opposing sides of the water intake unit each have the outlet end.

The effects of the present invention are described as below:

1. The use of a real flame represents the effect of water and fire homology, and the sense of sight is like the true landscape of nature.

2. The ornamental device of the present invention has a simple structure to achieve the effect of water and fire homology.

### BRIEF DESCRIPTION OF THE DRAWINGS

FIG. 1 is a perspective view of an ornamental device in accordance with a first embodiment of the present invention;

FIG. 2 is another perspective view of the ornamental device in accordance with the first embodiment of the present invention;

FIG. 3 is a schematic view of the ornamental device coupled with a gas canister in accordance with the first embodiment of the present invention;

FIG. 4 is a schematic view of the ornamental device in accordance with the first embodiment of the present invention when in use;

FIG. 5 is a perspective view of the ornamental device coupled with a first decorative panel and a second decorative panel in accordance with the first embodiment of the present invention;

FIG. 6 is a sectional view of FIG. 5;

FIG. 7 is a perspective view of the ornamental device coupled with the first decorative panel and the second decorative panel in accordance with the first embodiment of the present invention when in use;

FIG. 8 is a schematic view of the ornamental device mounted on a table in accordance with the first embodiment of the present invention;

FIG. 9 is a perspective view of the ornamental device in accordance with a second embodiment of the present invention; and

FIG. 10 is a sectional view of FIG. 9.

### DETAILED DESCRIPTION OF THE PREFERRED EMBODIMENTS

Embodiments of the present invention will now be described, by way of example only, with reference to the accompanying drawings.

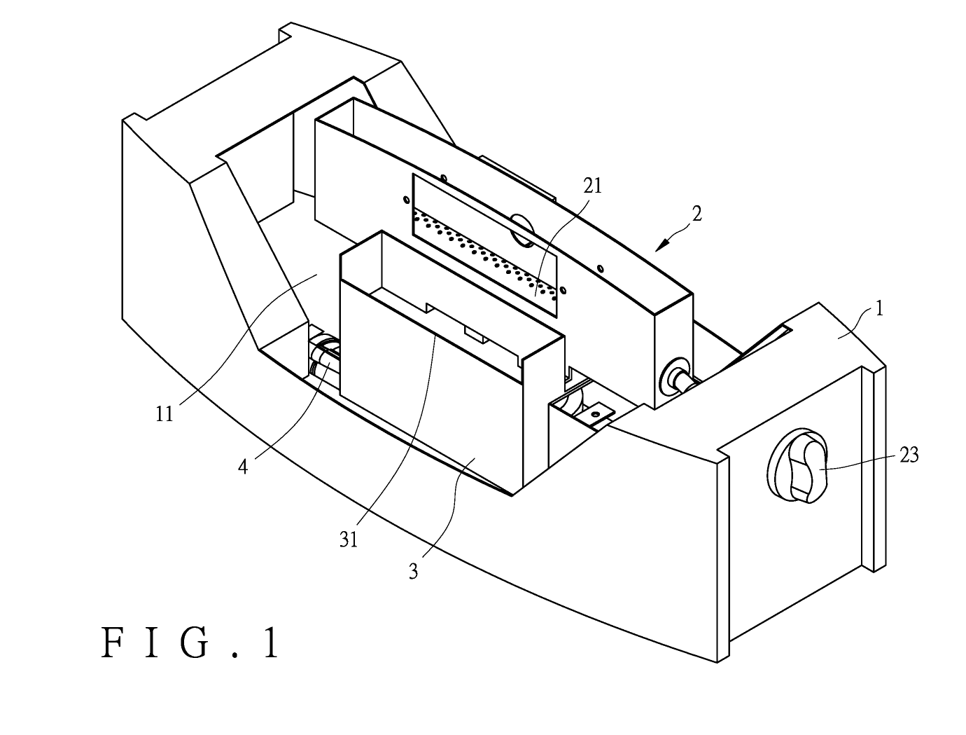

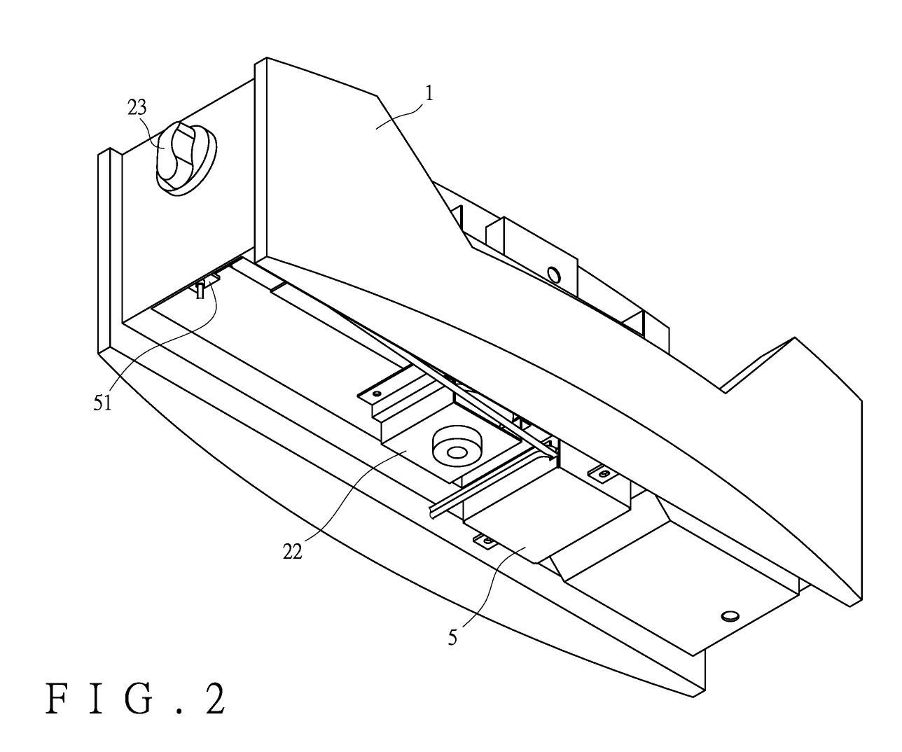

As shown in FIG. 1 and FIG. 2, a water and fire ornamental device in accordance with a first embodiment of the present invention comprises a casing 1, a fire source 2, a water tank 3, a pump motor 4, and a power source 5.

The casing 1 is recessed inward with an accommodation space 11. The fire source 2 is disposed on the casing 1. The fire source 2 includes a flame pipe 21 and a gas connector 22 connected to the flame pipe 21. A rotary switch 23 is connected with the gas connector 22. The water tank 3 is disposed on the casing 1. The water tank 3 has an overflow end 31 communicating with the accommodation space 11. In this embodiment, the water tank 3 has two overflow ends 31 at two opposing sides thereof. The pump motor 4 is in communication with the accommodation space 11 of the casing 1 and the water tank 3. The power source 5 is electrically connected with the pump motor 4. The power supply 5 includes a switch 51.

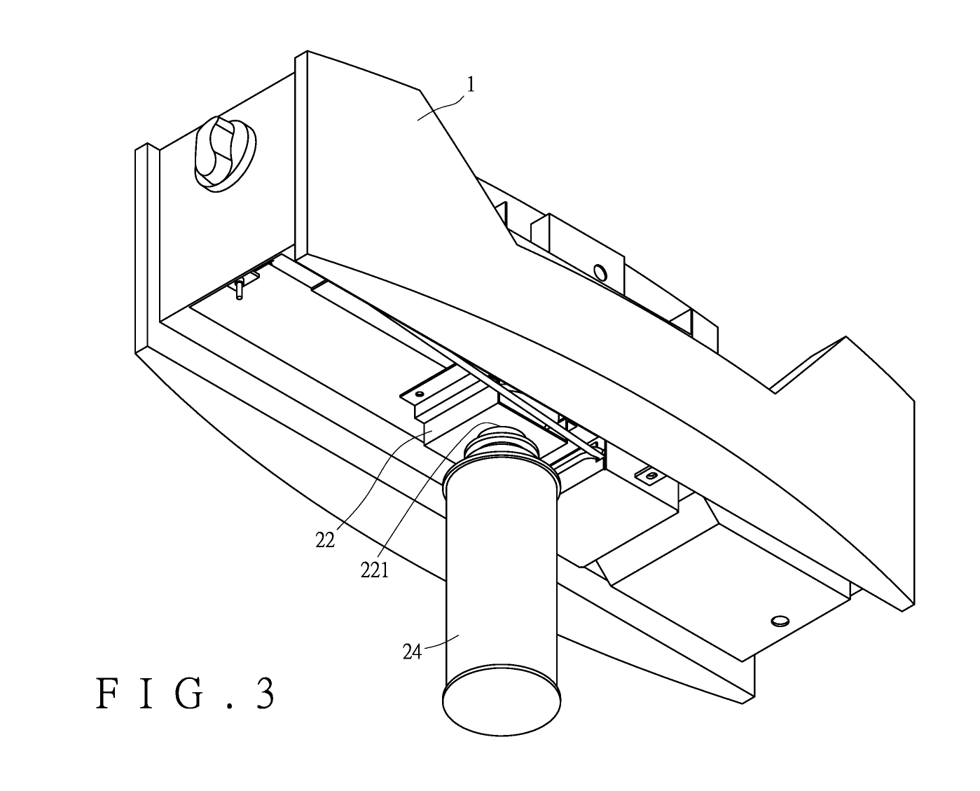

Referring to FIG. 3, the gas connector 22 has a gas connection end 221 extending outward from the bottom of the casing 1 for vertically connecting a gas canister 24, but not limited thereto. The gas connection end 221 may be horizontally disposed at the bottom of the casing 1 so that the gas canister 24 can be horizontally positioned in the casing 1 without taking up space. In practice, the gas canister 24 can be placed in a preferred manner depending on where the ornamental device is used and national laws and regulations.

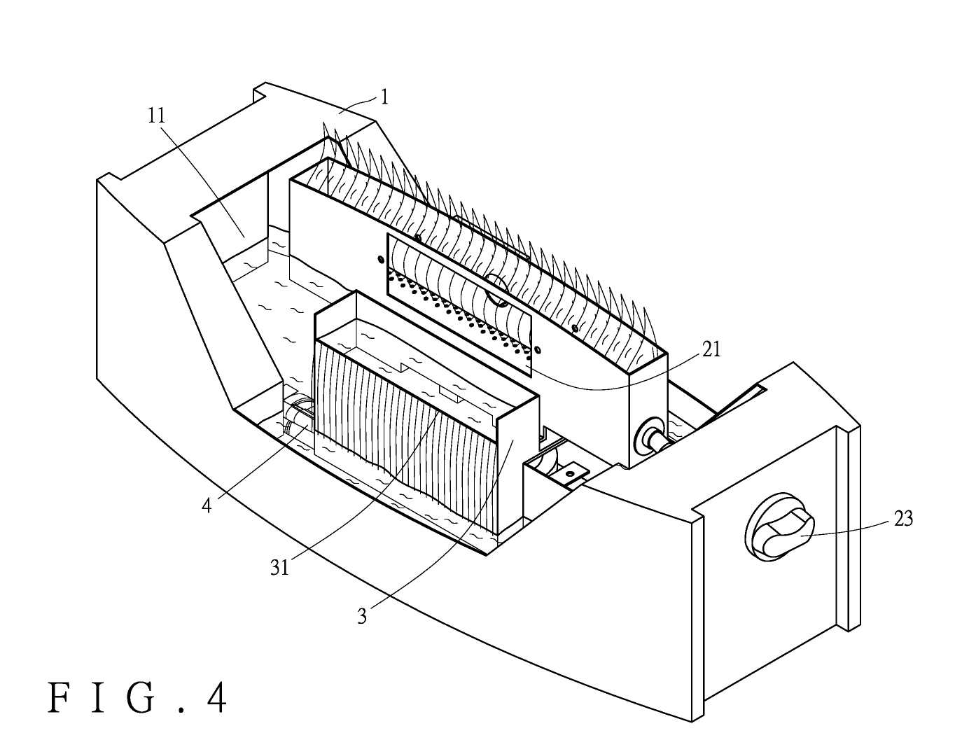

Referring to FIG. 4, the accommodation space 11 of the casing 1 is first poured with a liquid. Normally, the liquid is water. The gas canister 24 is connected to the gas connection end 221 of the gas connector 22, as shown in FIG. 3. After that, the rotary switch 23 is used to communicate the flame pipe 21 with the gas canister 24. The flame pipe 21 generates a flame after ignition. Then, the switch 51 of the power source 5 is turned on, referring to FIG. 2, such that the pump motor 4 pumps the water from the accommodation space 11 to the water tank 3 and the water flows back to the accommodation space 11 from the overflow end 31 of the water tank 3. The flame and the water stream from the overflow end 31 are visible from the outside the casing 1. Thereby, the real flame and the water stream present the effect of water and fire homology, so that the viewers may have the visual perception of the true landscape of nature. In addition, the water tank 3 has the respective overflow ends 31 at the two opposing sides thereof so that the viewers at different positions can enjoy the view of water and fire homology.

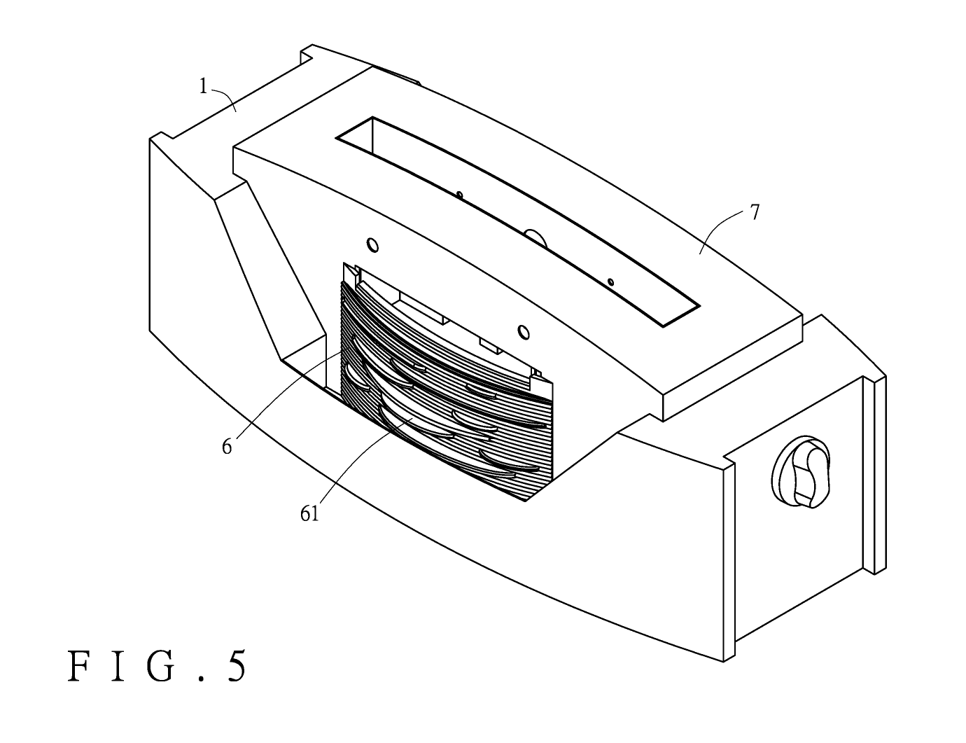

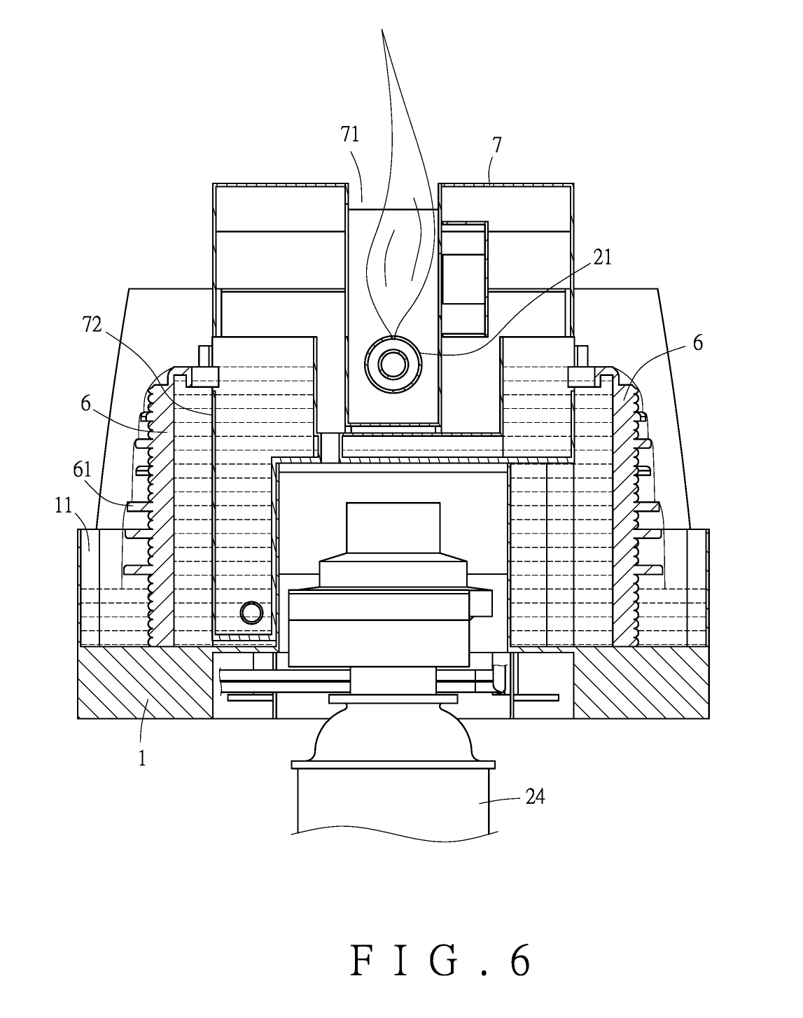

Referring to FIG. 5 and FIG. 6, in order to make the appearance of the ornamental device of the present invention more beautiful, in this embodiment, the casing 1 is provided with a first decorative panel 6 and a second decorative panel 7. The first decorative panel 6 is located close to the overflow end 31 of the water tank 3. The second decorative panel 7 covers the fire source 2 and the water tank 3.

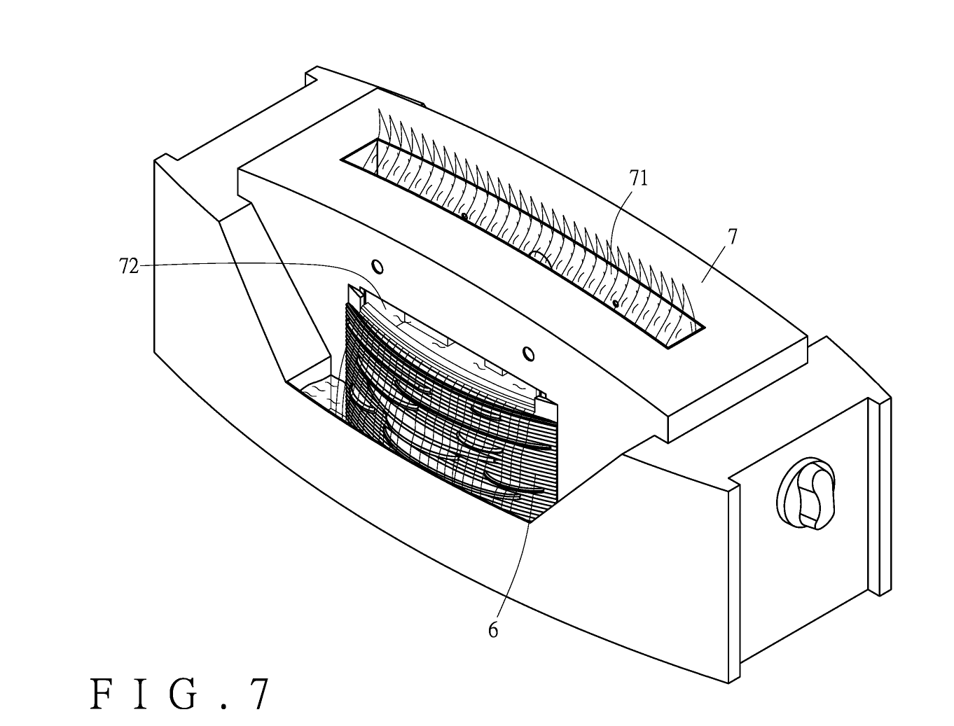

Referring to FIG. 6 and FIG. 7, the first decorative panel 6 has a plurality of ribs 61 thereon. The second decorative panel 7 has a first opening 71 corresponding to the flame pipe 21 and a second opening 72 corresponding to the overflow end 31 of the water tank 3. The second opening 72 is covered by the first decorative panel 6. Thereby, the flame comes out from the first opening 71, and the water overflows from the overflow end 31 to the top of the first decorative panel 6, and then flows from the top of the decorative panel 6 to the accommodation space 11 like a waterfall. The ribs 61 on the first decorative panel 6 can simulate the visual perception that the water hits a rock with a splash. The decoration of the first decorative panel 6 and the second decorative panel 7 makes the whole ornamental device more beautiful.

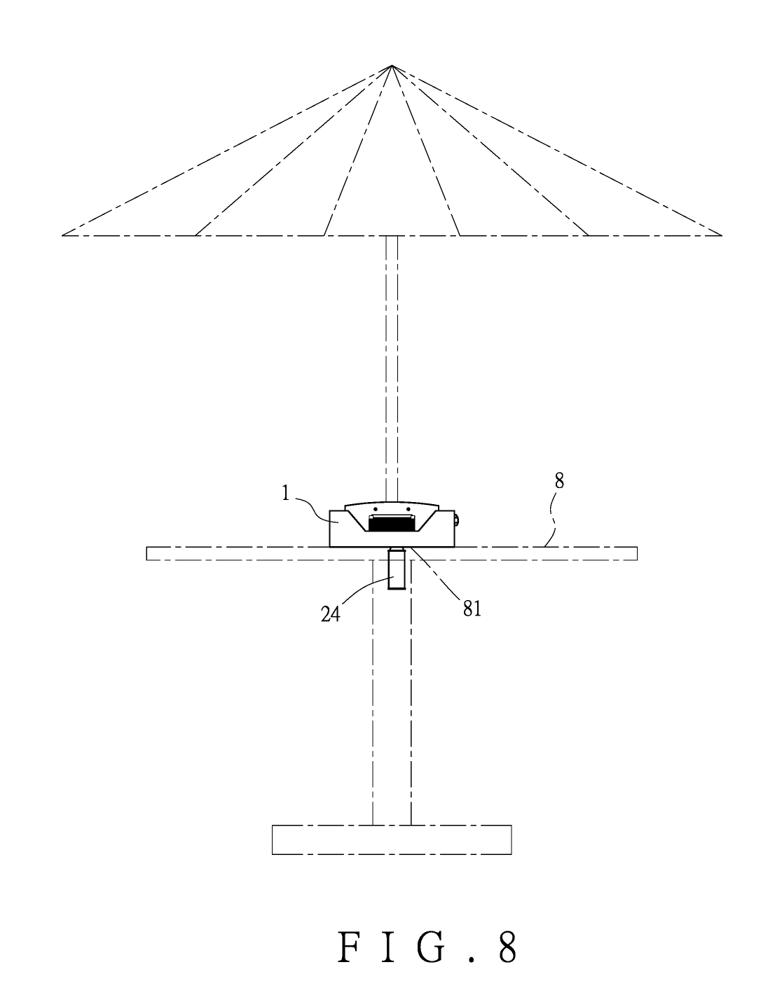

Referring to FIG. 8, the ornamental device of the present invention may be mounted on a table 8. The table 8 has an opening 81. The gas canister 24 is inserted through the opening 81 to the bottom of the table 8, such that the casing 1 can be placed on the table 8.

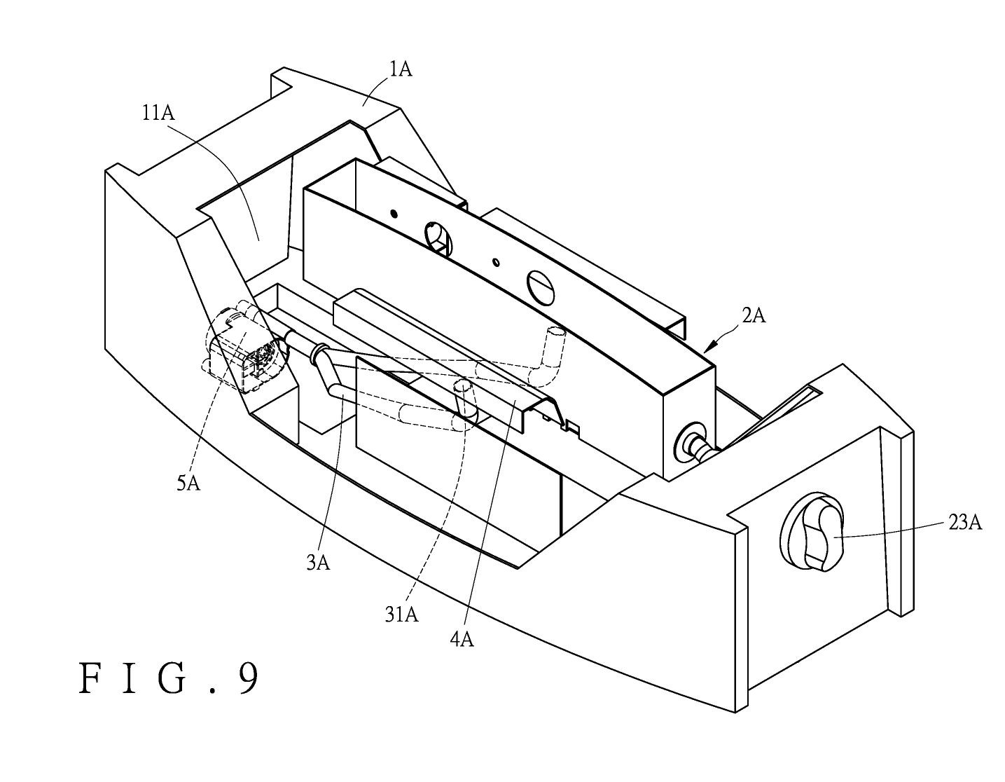

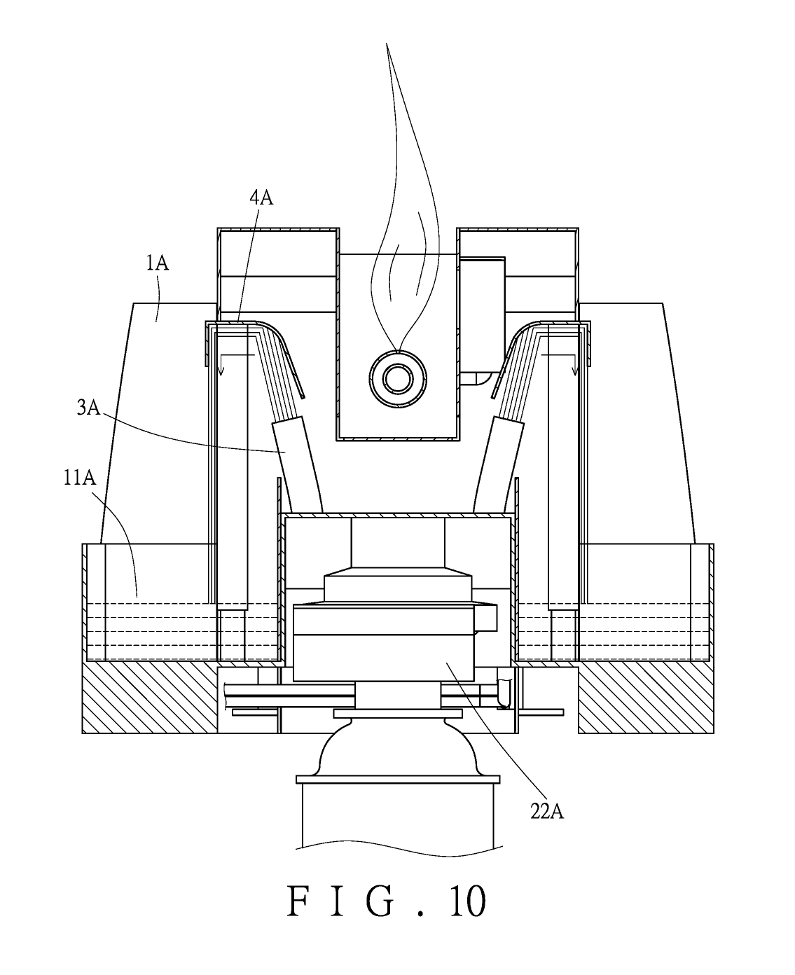

As shown in FIG. 9 and FIG. 10, a second embodiment of the present invention comprises a casing 1A, a fire source 2A, a water pipe 3A, and a pump motor 5A.

The casing 1A is recessed inward with an accommodation space 11A. The fire source 2A is disposed on the casing 1A. The fire source 2A includes a flame pipe 21A and a gas connector 22A connected to the flame pipe 21A. A rotary switch 23A is connected with the gas connector 22A. The water pipe 3A is disposed on the casing 1A. The water pipe 3A has an outlet end 31A facing up. A stop board 4A is provided and located corresponding to the outlet end 31A. The pump motor 5A is in communication with the accommodation space 11A of the casing 1A and the water pipe 3A.

The second embodiment is substantially similar to the first embodiment with the exceptions described hereinafter. After the water in the accommodation space 11A is pumped to the water pipe 3A, the water is ejected upward from the outlet end 31A. The ejected water is stopped by the stop board 4A to flow back to the accommodation space 11A like a waterfall, thereby achieving a visual perception of the interaction of the flame and the waterfall.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A water and fire ornamental device, comprising:
a casing, recessed inward with an accommodation space;
a fire source, disposed on the casing;
a water intake unit, disposed on the casing, the water intake unit having an outlet end communicating with the accommodation space;
a pump motor, being in communication with the accommodation space of the casing and the water intake unit;
a power source, electrically connected with the pump motor;
thereby, the fire source being used to generate a flame, the pump motor pumping a liquid from the accommodation space to the water intake unit, the liquid flowing back to the accommodation space from the outlet end of the water intake unit, the flame and the liquid flowing from the outlet end being visible from an outside the casing.

2. The water and flame ornamental device as claimed in claim 1, wherein the fire source includes a flame pipe and a gas connector connected to the flame pipe.

3. The water and fire ornamental device as claimed in claim 2, wherein the gas connector has a gas connection end extending outward from a bottom of the casing.

4. The water and fire ornamental device as claimed in claim 1, wherein the water intake unit is a water tank, and the outlet end is disposed at an overflow end of the water tank.

5. The water and fire ornamental device as claimed in claim 1, wherein the water intake unit is a water pipe, the water pipe has the outlet end facing up, and a stop board is provided and located corresponding to the outlet end so that the liquid is stopped by the stop board to flow back to the accommodation space when the liquid is ejected upward from the outlet end.

6. The water and fire ornamental device as claimed in claim 1, wherein the casing is provided with a first decorative panel, the first decorative panel is located close to the outlet end of the water intake unit, and the first decorative panel has a plurality of ribs thereon.

7. The water and fire ornamental device as claimed in claim 6, wherein the casing is provided with a second decorative panel, the second decorative panel covers the fire source and the water intake unit, the second decorative panel has a first opening for the flame to come out and a second opening corresponding to the outlet end of the water intake unit, and the second opening is covered by the first decorative panel.

8. The water and fire ornamental device as claimed in claim 1, wherein two opposing sides of the water intake unit each have the outlet end.
